(19) United States
(12) Patent Application Publication
(10) Pub. No.: US 2019/0121405 A1
(43) Pub. Date: Apr. 25, 2019

(54) HEAT AND SOUND DEFLECTOR

(71) Applicant: Hewlett-Packard Development Company, L.P., Houston, TX (US)

(72) Inventors: John Pennington, JR., Palo Alto, CA (US); Joshua Little, Palo Alto, CA (US); Glenn Wong, Palo Alto, CA (US); Jack Godfrey Wood, Palo Alto, CA (US)

(21) Appl. No.: 16/089,560

(22) PCT Filed: Jun. 2, 2016
(86) PCT No.: PCT/US2016/035475

§ 371 Date: Sep. 28, 2018

(51) Int. Cl. G06F 1/20; H04R 1/34

(52) U.S. Cl. CPC G06F 1/20; H04R 1/028; H04R 1/345

(57) ABSTRACT

Examples disclosed herein relate to a heat and sound deflector. An example device includes a housing having a top side; an audio system disposed in the housing to emit sound toward the top side of the housing; a heat dissipation system disposed in the housing to dissipate heat toward the top side of the housing. In examples, a deflector disposed on the top side of the housing is to deflect the sound and the dissipated heat.

### BACKGROUND

Various devices may produce heat and emit sound. Dissipation of generated heat may be accomplished through various mechanism. Sound may be emitted through various openings.

### BRIEF DESCRIPTION OF THE DRAWINGS

The following detailed description references the drawings, wherein:

FIG. 1 is a schematic view of an example electronic device.

FIG 2 is a partial enlarged front view of the electronic device of FIG. 1.

FIG. 3 is a partial enlarged side view of the electronic device of FIG. 1.

FIG. 4 is a perspective view of an example computing device.

### DETAILED DESCRIPTION

In the following discussion and in the claims, the “electronic device” or “device” may be any device operating under electrical power which may generate heat during operation, such as, a computing device, radios, televisions, portable audio players, electronic musical instruments, etc. A “computing device” may be a desktop computer, laptop (or notebook) computer, workstation, tablet computer, mobile phone, smart phone, smart device, or any other device or equipment including a processor resource. A processing resource may include, for example, one processor or multiple processors included in a single computing device or distributed across multiple computing devices. A “processor” may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution of instructions stored on a machine-readable storage medium, or a combination thereof.

An electronic device may include components that generate heat. A heat dissipation system may be required to efficiently transfer the generated heat away from heat sensitive components. However, as electronic devices become smaller in size, the heat dissipation system may hinder the potential reduction in size. An electronic device may include audio systems to generate and emit sound. Users may seek electronic devices that provide good audio quality. However, as electronic devices become smaller in size, the components needed to provide a good quality audio system may hinder the potential reduction in size.

To address these issues, in the examples described herein, a heat and sound deflector may be disposed in a housing of a device including an audio system and a heat dissipation system. In examples, the heat and sound deflector is disposed to deflect sound and dissipated heat from the housing. In some examples, the deflected sound may be deflected up to 360 degrees around the device. In some examples, dissipated heat may be deflected up to 360 degrees around the device. In such examples, the heat dissipation system and audio system may be disposed to reduce the size of the electronic device,

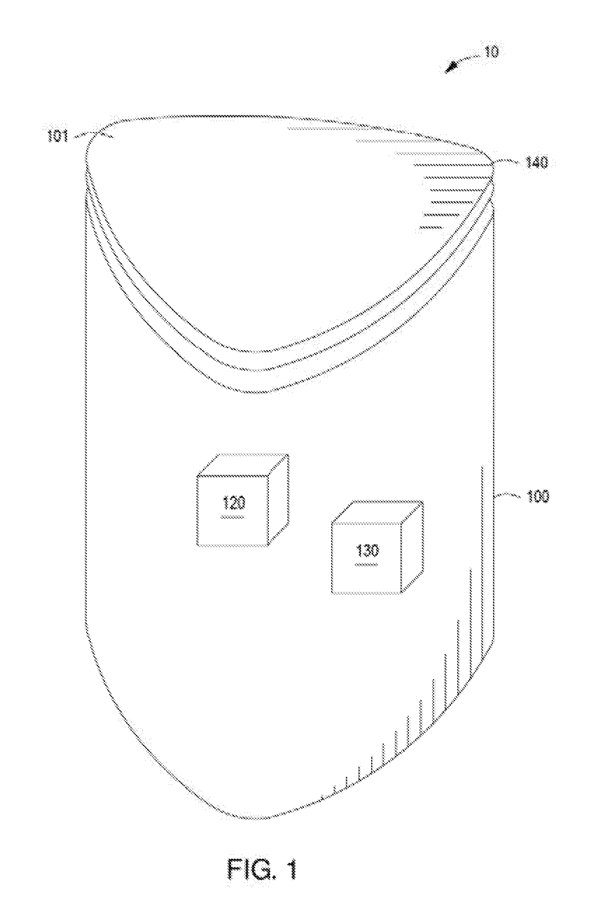

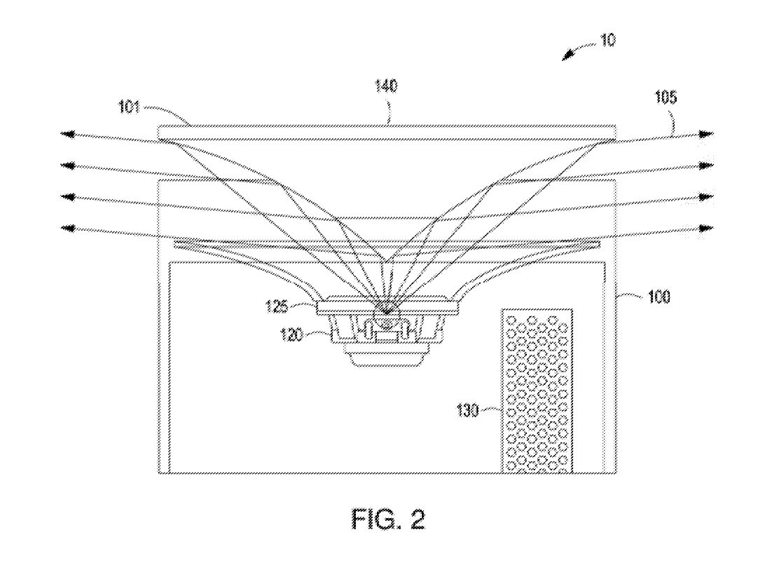

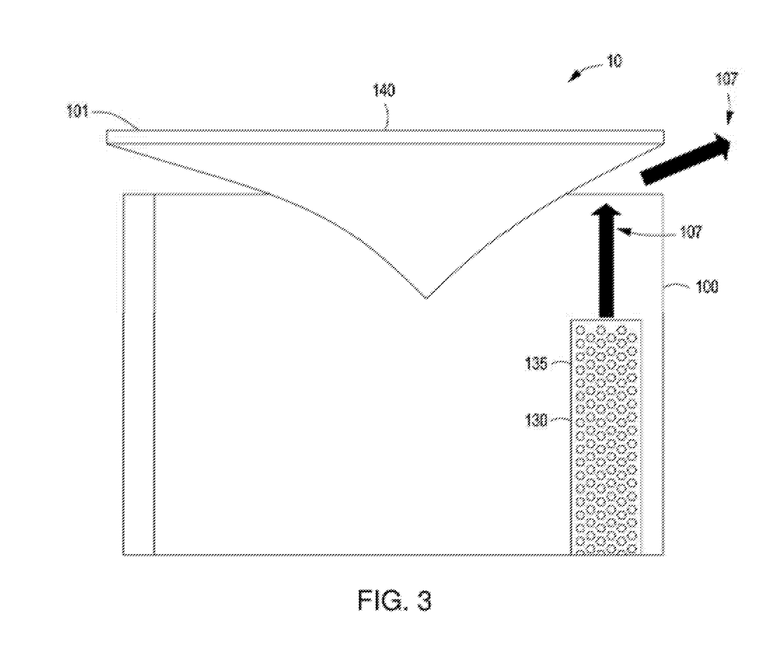

Referring now to the drawings, FIG. 1 is a schematic view of an example electronic device 10. FIG. 2 is a partial enlarged front view of electronic device 10 of FIG. 1. FIG. 3 is a partial enlarged side view of electronic device 10 of FIG. 1. In the example of FIGS. 1-3, electronic device 10 may include a housing 100 to house an audio system 120, a heat dissipation system 130, and a deflector 140.

In examples, housing 100 may include a side 101. In examples, side 101 may be a top side of device 10. Although depicted as a substantially triangular prism, housing 100 may be configured in any shape to allow an audio system, a heat dissipation system, and a deflector to be disposed therein. In examples, housing 100 may be composed of one or more of a metal, a plastic, a ceramic, a glass, a fabric, a composite, wood, etc.

In an example, audio system 120 may be a system to convert an electrical audio signal into a corresponding emitted sound. In some examples, audio system 120 may include one or more electroacoustic transducer or drivers to convert the electrical audio signal into sound. In such an example, audio system 120 may also include an amplifier to amplify the sound. In examples, audio system 120 may be disposed to generate or emit sound waves 105 towards side 101 of housing 100. In examples, various parameters of audio system 120 may be selected for the particular use and design of device 10. For examples, audio system 120 may include a transducer 125 to generate or emit sound waves 105. In such an example, transducer 125 may be disposed in housing 100 such that sound waves 105 are emitted toward deflector 140.

In an example, heat dissipation system 130 may be any system to dissipate heat from electronic device 10. In some examples, heat may be dissipated by any one of conduction, convection, or radiation. In examples, heat dissipation system 130 may include one or more of a heat sink, heat pipes, air moving devices, etc. to dissipate heat. As used herein, “air moving devices” may include any device designed to move air in a system, such as fans, impellers, blowers, etc. In examples, heat dissipation system 130 may be configured to dissipate heat away from heat sensitive components in device 10. For example, in a computing device, heat dissipation system 130 may be configured to dissipate generated heat away from a processing resource. In examples, heat dissipation system 130 may be disposed to dissipate heat towards side 101 of housing 100. In examples, various parameters of heat dissipation system 130 may be selected for the particular use and design of device 10. For examples, heat dissipation system 130 may include air moving device 135 to move air through device 10. In such an example, heat dissipation system 130 may be disposed in housing 100 such that heated air or heat waves 107 are dissipated toward deflector 140. In examples, heat dissipation system 130 may be disposed to be offset from audio system 120 in housing 100. In such an example, heat dissipation system 130 and audio system 120 may be disposed to reduce the size of device 10.

In an example, deflector 140 may be configured to deflect sound and heat. In examples, deflector 140 may be disposed in housing 100 to extend from a central opening of housing 100 to form a part of side 101. In an example, an upper surface of deflector 140 may form side 101. Various parameters of deflector 140 may be selected for the particular use and design of device 10. For example, the dimensions, orientation, and material choice of deflector 140 may be determined by the size of the device 10 and the particular use of device 10. In examples, deflector 140 may be cone or other three-dimensional shape to deflect heat and sound. Although depicted as a cone with a substantially triangular base which mirrors a cross-sectional shape of housing 100, deflector 140 is not limited thereto and deflector 140 may have a different shaped base from housing 100. In examples, deflector 140 may be composed of one or more of a metal, a plastic, a ceramic, a glass, a composite, wood, etc.

In examples, audio system 120 and heat dissipation system 130 may be disposed in housing 100 so that the sound waves 105 and heat waves 107 are deflected radially by deflector 140 around housing 100. In examples, sound waves 105 may be deflected radially in a range of 1 to 360 degrees around housing 100. For example, sound waves 105 may be deflected 360 degrees around housing 100 to provide a sound to users positioned anywhere around device 10. In other examples, sound waves 105 may be deflected up to 180 degrees around housing 100. In another example, sound waves 105 may be deflected up to 90 degrees around housing 100 In examples, heat waves 107 may be deflected radially in a range of 1 to 360 degrees around housing 100. For example, heat waves 107 may be deflected 360 degrees around housing 100. In other examples, heat waves 107 may be deflected less than 360 degrees to dissipate heat to a certain region around housing 100. In examples, the particular amount of deflection of sound waves 105 and/or heat waves 107 around housing 100 may be selected for the particular use and design of device 10. For examples, device 10 may be designed to emit sound and dissipate heat based on the planned usage location of device 10, for example, in the center of a room, a corner of a room, against a wall, etc.

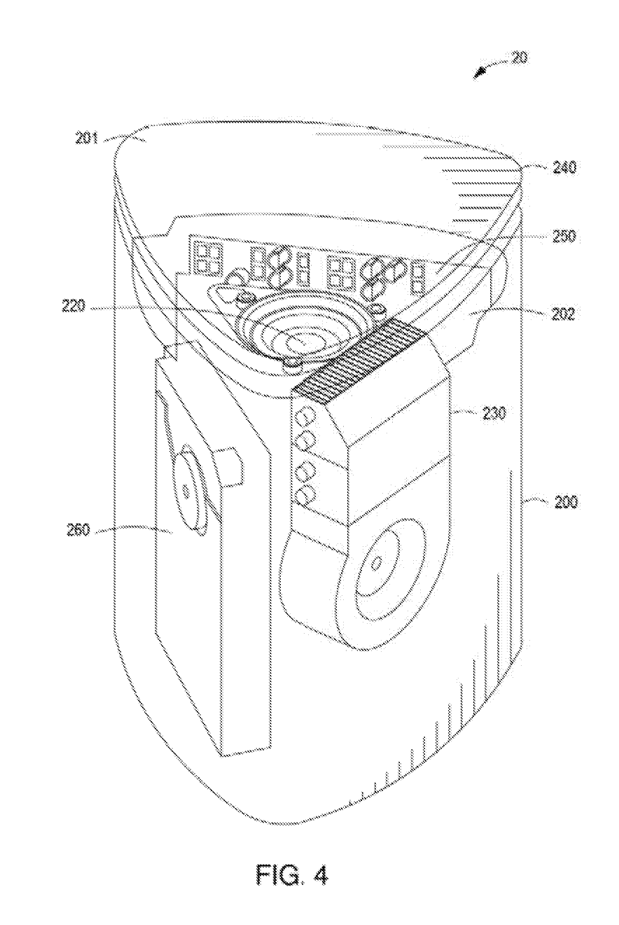

FIG. 4 is a perspective view of an example computing device 20. Computing device 20 may include housing 200 to house an audio system 220, a heat dissipation system 230, a deflector 240, a motherboard 250 including one or more processing resources, and a storage medium 260. Any storage medium described herein may be any of Random Access Memory (RAM), volatile memory, non-volatile memory, flash memory, a storage drive (e.g., a hard drive), a solid state drive, any type of storage disc (e.g., a compact disc, a DVD. etc.), and the like, or a combination thereof. Further, any storage medium described herein may be non-transitory.

In examples, housing 200 may include a side 201. In examples, side 201 may be a top side of device 20. In examples, housing 200 may include a central opening 202. Although depicted as a substantially triangular prism, housing 200 may be configured in any shape to allow audio system 220, heat dissipation system 230, deflector 240, motherboard 250, and storage medium 260 to be disposed therein. In examples, housing 200 may be substantially similar to housing 100 described with respect to FIGS. 1-3. In examples, audio system 220 may be substantially similar to audio system 120 described with respect to FIGS. 1-3. In examples, heat dissipation system 230 may be substantially similar to heat dissipation system 130 described with respect to FIGS. 1-3. In examples, deflector 240 may be substantially similar to deflector 140 described with respect to FIGS. 1-3.

In the example of FIG. 4, computing device 20 may include heat sensitive components on motherboard 250 and storage medium 260. In such an example, heat dissipation system 230 may dissipate heat generated by processing resources on motherboard 250 and storage medium 260 towards deflector 240 to be deflected outside housing 200. In examples, heat dissipation system 230 may include a number of components (not all shown) to dissipate generated heat including an air mover device to move hot air toward deflector 240 for deflection outside housing 200. In examples, deflector 240 may deflect emitted sound and dissipated heat radially from housing in a similar manner as shown in FIGS. 2-3.

In operation, audio system 220 may emit sound toward deflector 240 to be deflected around housing 200. In examples, audio system 220 may be disposed in housing 200 to be substantially aligned with central opening 202 of housing 200. In examples, heat dissipation system 230 may be disposed to be offset from audio system 220 in housing 200. In an example, deflector 240 may be disposed to extend from central opening 202 of housing 200 such that an upper surface of deflector 240 forms at least part of side 201. In such an example, deflector 240 may be substantially aligned with central opening 202 of housing 200.

In examples, various components of device 20, such as audio system 220, heat dissipation system 230, and deflector 240, etc., may be disposed in housing 200 to select a range of deflection for generated sound and dissipated heat. In examples, generated sound and dissipated heat may be deflected in a range of 1 to 360 degrees around housing 200. In other examples, generated sound and dissipate head may be deflected in different ranges from each other. For example, generated sound may be deflected up to 360 degrees around housing 200 and dissipated heat may be deflected up to 180 degrees around housing 200. In such an example, deflected sound waves and heat waves may interfere with each other for up to 180 degrees around housing 200. In another example, generated sound may be deflected up to 360 degrees around housing 200 and dissipated heat may be deflected up to 90 degrees around housing 200. In such an example, deflected sound waves and heat waves may interfere with each other for up to 90 degrees around housing 200.

In the various examples described herein, the use of a deflector to deflect sound and heat may allow for a more compact arrangement of components in a device. In such examples, the sound and heat may be radially deflected from the housing of the device. In examples, the amount of deflection of sound and heat around a housing may be selected to provide good quality audio and efficient heat dissipation. For example, in such a device, sound and dissipated heat may be deflected up to 360 degrees around the device.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be understood that the systems, and apparatuses described herein can include various combinations and/or sub-combinations of the components and/or features of the different implementations described. Thus, features described with reference to one or more implementations can be combined with other implementations described herein.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

1. An electronic device comprising:
a housing having a top side;
a audio system disposed in the housing to emit sound toward the top side of the housing;
a heat dissipation system disposed in the housing to dissipate heat toward the top side of the housing; and
a deflector disposed on the top side of the housing to deflect the sound and the dissipated heat.

2. The device of claim 1, wherein the deflector is to deflect the sound in a range up of 1 to 360 degrees around the housing.

3. The device of claim 1, wherein the deflector is to deflect the dissipated heat in a range of 1 degrees to 360 degrees around the housing.

4. The device of claim 1, wherein the audio system includes a driver disposed to emit sound towards the deflector.

5. The device of claim 1, wherein the heat dissipation system includes an air mover device to dissipate heat towards the deflector.

6. The device of claim 1, further comprising:
a central processing unit disposed in the housing,
wherein the heat dissipation system is to dissipate heat generated by the central processing unit.

7. The device of claim 1, further comprising:
a storage medium,
wherein the heat dissipation system is to dissipate heat generated by the storage medium.

8. A computing device, comprising:
a housing;
a central processing unit disposed in the housing;
a heat dissipation system disposed in the housing to dissipate heat generated by the central processing unit towards a first side of the housing;
an audio system disposed in the housing to generate sound waves directed toward the first side of the housing; and
a deflector to deflect the generated sound waves and dissipated heat radially from the housing,
wherein the heat dissipation system is offset from the audio system.

9. The computing device of claim 8, wherein the deflector is to deflect the dissipated heat in a range of 1 degrees to 360 degrees around the housing.

10. The device of claim 8, wherein the deflector is to deflect the generated sound waves in a range of 1 degrees to 360 degrees around the housing.

11. The computing device of claim 8, wherein the deflector is to deflect the generated sound waves in a range of 1 degrees to 180 degrees around the housing.

12. The computing device of claim 6, wherein the deflector is to deflect the generated sound waves in a range of 1 degrees to 90 degrees around the housing.

13. A computing device, comprising:
a housing having a top side, wherein the top side includes a central opening;
a central processing unit disposed in the housing;
a heat dissipation system disposed in the housing to dissipate heat generated by the central processing unit towards the central opening;
an audio system disposed in the housing to be aligned with the central opening to emit sound waves towards the central opening; and
a deflector extending from the central opening of the top side to deflect the sound waves and dissipated heat radially from the housing.

14. The computing device of claim 13, wherein the deflected sound waves interfere with the dissipated heat for up to 180 degrees around the housing.

15. The computing device of claim 13, wherein the deflected sound waves interfere with the dissipated heat for up to 90 degrees around the housing.
